(19) United States
(12) Patent Application Publication
(10) Pub. No.: US 2025/0123378 A1
(43) Pub. Date: Apr. 17, 2025

(54) DEVICE AND METHOD FOR TESTING A LIDAR SENSOR

(71) Applicant: dSPACE GmbH, Paderborn (DE)

(72) Inventors: Andreas HIMMLER, Paderborn (DE); Stefan SCHUKAT, Paderborn (DE); Rainer WOLSFELD, Borchen (DE); Jan LACHMAIR, Bielefeld (DE); Christian PILGER, Bielefeld (DE)

(73) Assignee: dSPACE GmbH, Paderborn (DE)

(21) Appl. No.: 18/916,629

(22) Filed: Oct. 15, 2024

(30) Foreign Application Priority Data
Oct. 13, 2023 (DE) 10 2023 128 065.1

(51) Int. Cl. G01S 7/497; G01S 7/481

(52) U.S. Cl. CPC G01S 7/497; G01S 7/4812; G01S 7/4815

(57) ABSTRACT

A device for testing a lidar sensor, the lidar sensor being configured to emit first light. A trigger detector is configured to receive the first light on a first optical path, the trigger detector being configured to generate a trigger signal as a function of the received first light. At least one transmitting device that is configured to emit second light as a function of the trigger signal. The second light being receivable on a second optical path by the lidar sensor. A movement device is configured to move the at least one transmitting device.

This nonprovisional application claims priority under 35 U.S.C. § 119(a) to German Patent Application No. 10 2023 128 065.1, which was filed in Germany on Oct. 13, 2023, and which is herein incorporated by reference.

### BACKGROUND OF THE INVENTION

### Field of the Invention

The present application relates to a device and a method for testing a lidar sensor, and to a test stand, in particular a roller test stand, for testing the lidar sensor.

### Description of the Background Art

A device and a method for isolating a trigger signal for a test system of a lidar sensor are described in DE 102021106220 A1, which corresponds to US 2022/0291355. An optical element is provided which is arranged in front of a converging lens or a trigger detector and situated in a signal path of the trigger signal. The optical element is designed to allow the trigger signal to pass through, and to at least partially absorb a back reflection of the trigger signal that passes through the optical element and that is reflected in particular at a surface. The polarization of the light is utilized for this purpose. The optical element may be designed as an optical isolator, in particular as a Faraday isolator, wherein the Faraday rotator in this case is situated between a first polarizer and a second polarizer.

### SUMMARY OF THE INVENTION

It is therefore an object of the present invention to provide a lidar sensor that is configured to emit first light, and provide a device for testing the lidar sensor that comprises: a trigger detector that is configured to receive the first light on a first optical path, the trigger detector being configured to generate a trigger signal as a function of the received first light, at least one transmitting device that is configured to emit second light as a function of the trigger signal, the second light being receivable on a second optical path by the lidar sensor, and a movement device that is configured to move the at least one transmitting device as a function of the trigger signal.

In an example, a method for testing the lidar sensor comprises: emitting the first light by the lidar sensor, receiving the first light on the first optical path by the trigger detector, generating the trigger signal by the trigger detector as a function of the received first light, emitting second light by at least one transmitting device as a function of the trigger signal, and receiving the second light on a second optical path by the lidar sensor, wherein a movement device moves the at least one transmitting device as a function of the trigger signal.

More flexible adaptation and expansion of lidar test scenarios may be achieved by use of the device or the method for testing the lidar sensor. In general, it is noted that the term “light” is to be broadly interpreted, and has been selected for better readability. Electromagnetic waves are intended, which may also be present in nonvisible wavelength ranges.

Via a movement of the at least one transmitting device as a function of the trigger signal, the movement device allows various objects, which are simulated by the second light for the lidar sensor that is emitted by the at least one transmitting device, to be represented in a freely positionable manner, horizontally and/or vertically with respect to the lidar sensor. A high level of flexibility and a wide variety of test scenarios for the lidar sensor are thus possible. The number and movement of the simulated targets may be easily represented using such a movement device. By use of the movement device, the position in space at which the light is emitted may be flexibly and precisely set.

The described device and the described method for testing the lidar sensor allow the lidar sensor to be confronted, and thus tested, with various situations that may occur in reality. The situations are simulated for the lidar sensor by means of the second light. This type of testing may also be referred to as over-the-air (OTA) testing. It is thus possible, for example, to also check specified test cases that are prescribed by a contracting or regulatory authority, for example. The described device may be advantageously used in particular in a roller test stand in order to test a lidar sensor that is installed in a vehicle situated on the roller test stand.

With regard to assisted or autonomous driving, correct functioning of such a lidar sensor is imperative. The described device and the described method may be advantageously used to spare test drives and also to test, in a short period of time, a number of various traffic situations that may occur. The device and the method allow testing of the lidar sensor via an optical transmit/receive interface (over-the-air). This allows the lidar sensor to be tested, regardless of its installation and/or whether it is already installed, for example in a vehicle

The lidar sensor emits the first light by means of a light source, for example laser light via one or more laser diodes. The lidar sensor then evaluates received second light. If the lidar sensor is in the operating mode for surroundings detection, the second light generally involves back reflections from the surroundings of the lidar sensor. However, the evaluation of the second light, for example via the so-called time-of-flight principle or also via a Doppler shift, also allows determination of distances as well as movements of objects in the visual field of the lidar sensor. Movement of the objects may in particular mean the direction, or also the speed or acceleration or other motion parameters. A lidar sensor is often used in conjunction with other sensors, for example a radar sensor and/or a camera sensor, to obtain the necessary redundancy and reliability of such information concerning the visible objects.

The trigger detector, which is configured to receive the first light on a first optical path and to generate the trigger signal as a function of the received first light, has a receiver for the first light. The receiver of the trigger detector may convert the received first light into an electrical signal, for example, using an optical-electrical converter. For this purpose, the receiver may include photodiodes, other light-sensitive diodes, or electronic components, or also other optical-electrical converters such as a photomultiplier or an interferometer.

The at least one transmitting device can be configured to emit second light as a function of the trigger signal, the second light being receivable on a second optical path by the lidar sensor. For example, the transmitting device includes laser diodes or conventional light-emitting diodes which emit the second light. This emission is triggered by the trigger signal, which is an electrical signal, for example. The second light is received by the lidar sensor via the second optical path, the lidar sensor therefore likewise having an optical-electrical converter, for example photodiodes, PIN diodes, etc.

The device can be designed in such a way that the lidar sensor perceives the received second light as back reflection of its emitted first light. The received second light is evaluated by the lidar sensor and used for surroundings detection. By use of the second light that is transmitted by the transmitting device, it is thus possible for the lidar sensor to simulate the surroundings containing objects.

The movement device, which is configured to move the at least one transmitting device as a function of the trigger signal, may be designed to displace and/or tilt one or more transmitting devices, for example on rails or by means of robots or collaborative robots (cobots). The tilting of the transmitting devices may take place automatically, for example to allow the emission of the second light on a virtual sphere, i.e., a virtual spherical shape around the receiver of the lidar sensor. Multiple transmitting devices may in particular be moved, for example, displaced and/or tilted, independently of one another.

The movement device may be driven by an electric motor and may have a control unit, for example, which controls it. The control unit may then not only control, for example, the movement device for the at least one transmitting device, but may also determine, for example, which of the transmitting devices emits second light at which point in time. During the movement, for example, the control unit may then also control the automatic tilting of the at least one transmitting device. The control unit may also be situated in the at least one transmitting device, and may be designed to activate the movement device.

The movement device can be configured to change the location and/or the direction of the emission of the second light as a function of an object simulator. The location is the position of the at least one transmitting device. The direction of the emission may be influenced, for example, by the inclination, i.e., tilt, of the at least one transmitting device.

Furthermore, it is possible for the at least one transmitting device to include a field of light sources, the light sources being activatable independently of one another. A light source is the laser diode or light-emitting diode, for example, and a field of light sources can be a so-called array of laser diodes or light-emitting diodes. An array of laser diodes is also referred to as a laser array.

A field of light sources may also be referred to as a transmit matrix, and for example may have a field of pixels that can emit light. The transmitting device may also have multiple transmit matrices. Optionally, the optical properties of the light of the individual pixels may be improved via microlenses in the case of fields of microlens arrays (MLAs), for example by better concentration or collimation. It is then possible, for example, to also individually control, for example, individual pixels of the transmit matrix or the transmit matrices of the at least one transmitting device. The transmit matrices may, for example, be moved independently of one another by the movement device. They may be situated, for example, one on top of the other at various heights in order to have the greatest range of motion possible.

The at least one transmitting device may include one laser diode or multiple laser diodes, for example as an array. For example, an individual laser diode in a field of laser diodes, i.e., a laser diode array of the transmit matrix, may be controlled and activated in this way. By use of the at least one transmitting device, this enables a high level of flexibility with regard to the simulated reflection signals of the simulated objects, also synthetic objects, that the lidar sensor sees in its visual range.

Due to its design, a laser diode has a predefined aperture through which the second light is emitted. If this laser diode is tilted by the movement device, the direction of the aperture in question will also change, and the second light will be correspondingly emitted in a different direction. The displacement and tilting are preferably coordinated with one another in such a way that they are perceived as realistic and plausible by the lidar sensor.

A high level of flexibility with regard to the simulation of objects for testing the lidar sensor is thus possible. The location of the emission may be influenced by the location of the at least one transmitting device. The direction of the emission may be influenced by tilting of the at least one transmitting device. In addition, it is also possible to generate further simulated objects by superimposing the particular second light from respective activated laser diodes. The setting of the movement device and the resulting superimposition depend on the underlying test scenario. The evaluation of the test scenario and the setting of the movement device may be carried out by the control unit, for example.

A laser diode array or light-emitting diode array is manufacturable in mass production as a semiconductor product. In addition, controllability of the particular light sources is achievable by manufacturing using semiconductor technology, in that activation means for the particular laser diode are present. The activation means are designed to convert electrical signals into activation of the laser diode. The activation encompasses, for example, whether the laser diode emits second light at all, and if so, with what light intensity. However, other optical parameters of the second light may also be determined in this way. The activation means may therefore be designed as one or more processors, for example. By use of saved test scenarios, it is thus possible to simulate any desired targets for testing the lidar sensor, based on the activation and movement of the at least one transmitting device.

Multiple transmitting devices can be provided which are movable independently of one another by the movement device. The multiple transmitting devices may be activated and coordinated by the described control unit. The different transmitting devices may be placed, for example, on different rails, on different robots, or on different collaborative robots and/or also at different heights, so that these different transmitting devices are also displaceable one above the other. In this way, use may be made of the full range of motion for each transmitting device. This may also result in partial covering of one transmitting device by the other, which in turn allows further options for simulating targets for the lidar sensor.

It is further proposed to provide an object simulator that is designed to generate a control signal as a function of the trigger signal, wherein the emission of the second light is a function of the control signal, and the second light for the lidar sensor simulates an object. That is, the object simulator evaluates the trigger signal, generates the control signal, which is a function of the trigger signal, at least in part, and transfers the control signal to the at least one transmitting device and/or movement device. The control signal may determine, for example, which light sources are to emit light, the type or intensity of light which they emit, and how the movement of the individual transmitting devices with these light sources is to proceed. The control of the movement device takes place independently of the trigger signal. The emission of the control signal for the movement of the light sources is a function of the particular test scenario carried out by the object simulator. The object simulator may optionally have the function of the described activation device.

The device can include an optical element that is configured to separate the first optical path from the second optical path on the side of the optical element facing away from the lidar sensor. This separation may take place in particular geometrically, in that one of the optical paths or both optical paths undergo(es) a geometric change, in particular a change in direction, when it/they passes/pass through the optical element. The change in direction may also be only an angular change, for example.

A side of the optical element facing the lidar sensor refers to the area between the optical element and the lidar sensor. It is possible for multiple sides to face away from the lidar sensor, depending on the shape of the optical element. In that case, the sides facing away from the lidar sensor are those sides which do not face the lidar sensor. These sides are all included in the stated facing-away side.

The separation of the first and second optical paths is advantageous, since the situation may be avoided that first light emitted by the lidar sensor is reflected at the at least one transmitting device, and this reflection is received by the lidar sensor. Due to this received reflection, the lidar sensor could perceive the at least one transmitting device as an object in its surroundings. This may be avoided by use of the described device and the described method.

In addition, it is possible for the first light to be emitted at a first wavelength, and for the second light to be emitted at a second light wavelength, the first wavelength being unequal to the second wavelength, and the separation of the first optical path and of the second optical path being a function of the wavelength. The wavelength of the two light signals, namely, the first light and the second light, is thus used as a parameter for separating the two optical paths.

The optical element may include a dichroic mirror that is used for separation of the optical paths as a function of the wavelength. Dichroic mirrors are designed to combine or separate two or more light beams having different wavelengths. They may be designed as long-pass mirrors, for example, in which the long wavelengths are transmitted and the short wavelengths are reflected. In one design as a short-pass mirror, the short wavelengths are passed through and the long wavelengths are reflected. Dichroic mirrors may have an alternating layered structure. In the coating, metallic layers may alternate with dielectric layers. Alternatively, low-refractive and high-refractive dielectric layers may be used in alternation. Dichroic mirrors are also referred to as interference filters. Dichroic mirrors are able to reflect the light of a wavelength with very low loss, and are therefore suitable, for example, for lasers such as in lidar. For a dichroic mirror, the rate of reflection may be set very precisely and in practically any desired manner as a function of the wavelength by suitably selecting the number of layers, layer thickness, and/or refractive index of the dielectrics used, which is helpful for the desired wavelength-dependent separation of light, in particular from laser beams

The dichroic mirror can be designed to reflect the first light having the first wavelength on the first optical path, and to transmit the second light having the second wavelength on the second optical path. This means that the path of the first light is deflected and thus undergoes a geometric change. The second light may continue on its path. Also, the first light having the first wavelength can be transmitted, and the second light having the second wavelength can be reflected.

The use of various wavelengths makes it easily possible to efficiently separate the two optical paths by using the dichroic mirror, for example. It is possible for the first wavelength to be approximately 905 nm or approximately 1550 nm. The same applies for the second wavelength. The first and second wavelengths may be selected in such a way that both are in the range of approximately 905 nm or both are in the range of approximately 1550 nm. The first wavelength may be specified by the lidar sensor, namely, as the wavelength at which the lidar sensor operates. The second wavelength may be selected in such a way that separation of the optical paths by the dichroic mirror is made possible, but the lidar sensor perceives received second light having the second wavelength as a reflection of its emitted first light, for example due to the small difference from the first wavelength. In this way, the surroundings for the lidar sensor may be simulated and the lidar sensor may be tested.

Furthermore, it is possible for the at least one transmitting device and the trigger detector to be situated spatially separate from one another. This allows a particularly compact design of the device. Alternatively, it is possible to situate the trigger detector and the transmitting device on the same component. In addition to the separation of the first and second paths by the first optical element, further beam deflections may then be provided.

The trigger detector can be movable as a function of the location and/or the direction of the emission of the second light. This as well enables greater flexibility. The trigger detector may be moved by a dedicated movement device or by the movement device for the at least one transmitting device. It is also possible for a dedicated trigger detector to be associated with each transmitting device, and to also be moved corresponding to the location of the transmitting device. Since back reflections of the first light emitted by the lidar sensor are simulated by the transmitting device, the location of the particular transmitting device is a function of the location at which the trigger detector detects the first light. The possible locations of the transmitting devices for generating the second light are known. Thus, the spatial directions from which the second light may be generated are also known. The location of the trigger detector may be adapted in such a way that, for example, the trigger detector is available only at the locations for receiving the first light for which corresponding second light may also be generated.

At least one optical deflection unit can be provided in the second optical path, via which the second light emitted by the at least one transmitting device is deflectable to the optical element or to the lidar sensor. If the deflection unit is situated on the side of the second path facing away from the lidar sensor, it deflects the second light toward the optical element. If the deflection unit is situated on the side of the second path facing the lidar sensor, it deflects the second light toward the lidar sensor. That is, the second optical path also undergoes a change in direction as a result of this deflection unit. The optical deflection unit thus allows further optimization of the spatial configuration. The optical deflection unit may be designed as a mirror, or the optical deflection unit may include such a mirror.

Furthermore, it is possible for the first and/or the second optical path to include at least one further optical element. These may be further mirrors or a damper or some other optical element, such as a filter.

The described device for testing the lidar sensor may include a test stand, in particular a roller test stand, for a vehicle having a lidar sensor. It is thus possible to cost-effectively test the lidar sensor in the installed state. In particular, a particularly compact design of the test stand is made possible.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of the device,

FIG. 2 shows a schematic illustration of an example of the device,

FIG. 3 shows a schematic illustration of a test stand, and

FIG. 4 shows a flow chart of the method.

### DETAILED DESCRIPTION

FIG. 1 shows a device 10, and a lidar sensor LIDAR that emits first light L1 on a first optical path. The device 10 tests the lidar sensor LIDAR via the air, i.e., wirelessly and in particular via the optical interface of the lidar sensor. The lidar sensor LIDAR may, for example, already be installed in a vehicle 20.

A trigger detector TD receives the first light L1 and converts it into an electrical signal by means of an optical-electrical converter which includes a photodiode or PIN diode, for example. The electrical signal is processed in the trigger detector TD, and generates a trigger signal TS as a function of the electrical signal. The processing may involve signal conditioning in which the trigger signal TS is generated from the first light L1. Signal processing may take place which includes smoothing and/or amplification and also more. The processing in the trigger detector TD may also include, for example, pattern recognition and/or analysis of the first light L1 converted into an electrical signal, using one or more threshold values.

For the processing, the trigger detector TD may have signal processing means, for example a processor, wherein the signal processing means generate the trigger signal TS from the received light L1. Multiple trigger detectors TD may also be provided.

The trigger signal TS is transferred to an object simulator 14 via an electrical line, for example. It is also possible for the transfer of the trigger signal TS to be achieved via an optical signal or a radio signal, for example. The object simulator 14 may then include corresponding converters for converting the trigger signal TS into an electrical signal, which the object simulator 14 may process electrically.

The processing in the object simulator 14 may include, for example, recognizing that the lidar sensor LIDAR has emitted the first light L1, and the solid angle at which the emission took place. Based on this solid angle, the lidar sensor LIDAR would then also anticipate the return signal. The object simulator 14 can now simulate the surroundings for the lidar sensor LIDAR by simulating objects in the surroundings of the lidar sensor LIDAR and transferring a corresponding control signal SE to the transmitting device 12 and/or the movement device BE. The simulated objects may then be simulated by the transmitting device 12 for the lidar sensor LIDAR via emitted second light L2.

The control signal SE also includes information for the movement device BE concerning how the at least one transmitting device 12 is to be moved in order to send second light L2, based on the particular solid angle, in such a way that the desired objects are simulated at the desired locations. Saved data may also be used to form the control signal SE, wherein the saved data relate to which object scenarios are to be represented for the lidar sensor LIDAR, for example. However, other data, for example which occur during the testing of the lidar sensor LIDAR, may be included in the formation of the control signal SE. The movement device BE may therefore also include evaluation means for the control signal SE in order to appropriately move the transmitting devices 12 and to instruct how the second light L2 is to be emitted.

Multiple trigger detectors TD may also be provided. A particular trigger detector TD may optionally be associated with one of multiple transmitting devices 12, 12.1, 12.2 and/or multiple movement devices BE, and may generate the particular trigger signal TS for these devices. The trigger detectors TD may also have a movable design.

As a function of the trigger signal TS and the test scenario, the object simulator 14 thus generates the control signal SE, which the object simulator 14 electrically transfers to the transmitting device 12 and/or the movement device BE. Here as well, other forms of transfer such as by optical means or via radio would be possible. In the present case a hard-wired transfer is used.

The processing of the control signal SE by the transmitting device 12 and/or the movement device BE may also include pattern recognition, for example, wherein further factors may have an additional effect on the emitted second light L2. These factors include the objects that are to be simulated by the transmitting devices 12. These objects are generated by the object simulator 14, for example, and are communicated to the transmitting device 12 and/or the movement device BE via the control signal SE.

The movement device BE also includes control means for activating one or more actuators that move the at least one transmitting device 12. This may include the activation of individual light sources of the transmitting device 12, for example pixels of an array, for example which particular light sources are to emit the light L2 and/or the light intensity at which the individual light sources are to emit.

The transmittal of the control signal SE to the at least one transmitting device 12, which emits second light L2, may also take place via the movement device BE. Conversely, the transmittal of the control signal SE to the movement device BE, which is to move the at least one transmitting device 12, may also take place via the transmitting device 12. Optionally, the control signal SE may also be transferred to the transmitting device 12 and the movement device BE.

The object simulator 14 is used to simulate the objects that the lidar sensor LIDAR is intended to be able to see in its visual range, for example to test the lidar sensor LIDAR. The objects are simulated in such a way that via the transmitting devices 12, artificial reflection signals are emitted on a second optical path by second light that is generated in the transmitting device 12. Various objects, object locations, object sizes, and/or object characteristics may be simulated using the second light L2.

For this purpose, the device 10 may include one or more transmitting devices 12, 12.1, 12.2, which in turn may each have one or more light sources. A particular transmitting device 12, 12.1, 12.2 may be movable, in particular displaceable and tiltable, with respect to other transmitting devices by means of the movement device BE. The movement of individual light sources of a transmitting device 12, 12.1, 12.2 relative to one another via the movement device BE is also conceivable. A particular light source may have, for example, an individual laser source which may be arranged, for example, in the form of fields, also referred to as arrays. The lasers or laser arrays may thus be mechanically displaced and/or tilted, for example, via the movement device BE. Due to the displaceability, tracking of objects by the lidar sensor LIDAR may also be tested. The mechanical displacement may take place in one or more directions. The lidar sensor LIDAR may thus be tested for whether the lidar sensor LIDAR can receive, distinguish, and identify all of these test objects that are simulated by the transmitting devices 12. This later makes it possible to correctly guide a vehicle 20 as a function of its surroundings, which have been detected by the lidar sensor LIDAR, or by providing a driver with information about what actions to take.

The transmitting device 12 thus sends the second light L2 on the second optical path as a function of the control signal SE. The second light L2 is received by the lidar sensor LIDAR via the second optical path, converted into an electrical signal, and further processed. If the received second light L2 is perceived by the lidar sensor LIDAR as a reflection of the emitted first light L1, the simulation of objects may be enabled and the lidar sensor LIDAR may be tested. By use of the device 10, the light L1 is not reflected by real objects; instead, the reflected light is simulated by the second light L2. A flexible option is thus provided for offering the lidar sensor LIDAR different types of objects in various situations.

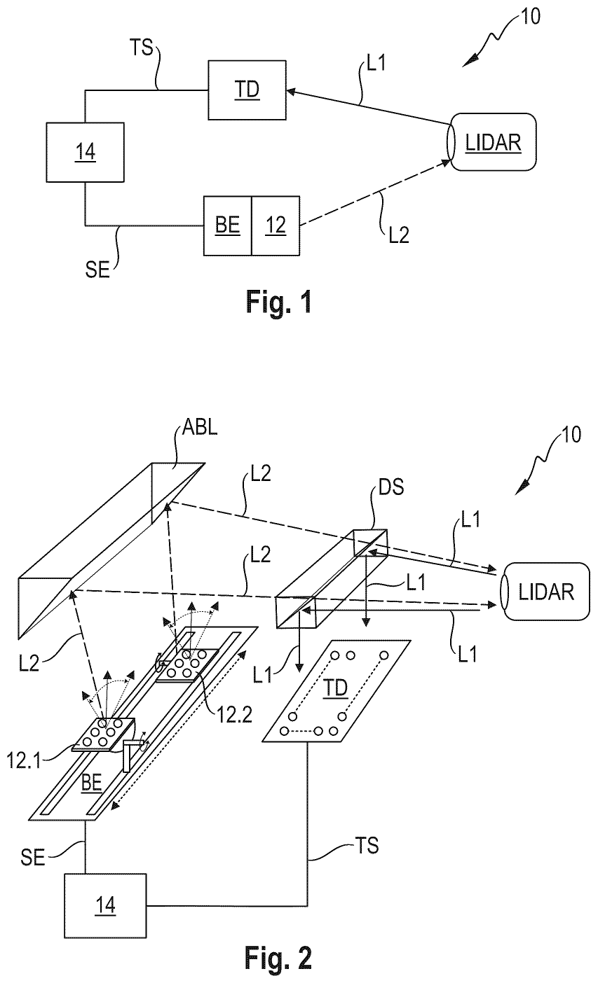

FIG. 2 shows a schematic illustration of an example of the device 10. The device 10 is connected to a lidar sensor LIDAR via the air. The lidar sensor LIDAR emits first light L1 having a first wavelength on a first optical path, which is deflected onto the trigger detector TD by the optical element DS. The optical element DS may be designed in particular as a dichroic mirror which is configured in such a way that it reflects light having the first wavelength.

The object simulator 14 generates, as a function of this trigger signal TS, the control signal SE which the object simulator 14 transfers to the transmitting device 12 and/or the movement device BE.

The trigger detector TD includes various receiving elements which are optionally also displaceable. These receiving elements, for example photodiodes or other optoelectrical converters, may optionally be displaced corresponding to the displacement of the transmitting devices 12.1, 12.2. The trigger detector TD generates, as a function of the received first light L1, a trigger signal TS which is transferred to the object simulator 14 as described. As described, the object simulator 14 generates from the trigger signal, possibly from saved data and optionally further data, the control signal SE for the movement device BE and/or the transmitting device 12. The control signal SE is in particular also a function of the objects to be simulated for the lidar sensor LIDAR.

The device 10 has two different transmitting devices 12.1 and 12.2 in the example. These transmitting devices are moved toward one another or with one another and/or are movable toward one another. The movement encompasses in particular displacement and/or tilting. The transmitting devices 12.1 and 12.2 have one or more light sources as transmitting elements, which emit the second light L2 at a second wavelength on a respective second optical path as a function of the control signal SE. The transmitting devices 12.1 and 12.2 may have the same or different designs.

The second light L2 having the second wavelength is deflected onto the lidar sensor LIDAR via the deflection unit ABL, with the second light L2 passing through the optical element DS. The optical element DS is designed in such a way that it separates the first optical path and the second optical path due to the wavelength. The optical element DS may be designed as a dichroic mirror, and configured in such a way that it allows light having the second wavelength to pass through, i.e., is transparent to light having the second wavelength.

The second wavelength of the second light L2 differs from the first wavelength such that the second light L2 is guided by the optical element DS, which may be designed as a dichroic mirror. The optical element DS is designed in such a way that it allows light of the second wavelength to pass through. The second light L2 thus passes through the dichroic mirror, and then strikes the lidar sensor LIDAR on the side of the lidar sensor LIDAR facing the optical element DS. The second light L2 is received by the lidar sensor LIDAR, converted into an electrical signal, and further processed. The second wavelength is selected in such a way that it is far enough away from the first wavelength to enable the separation by the optical element DS. The second wavelength is likewise selected in such a way that it is close enough to the first wavelength to be perceived by the lidar sensor LIDAR as a reflection of the emitted first light L1. The simulation of objects is then enabled, and the lidar sensor LIDAR may be tested.

By use of the deflection unit ABL it is possible to lengthen the second optical path for the second light L2, which is important for a realistic test of the lidar sensor LIDAR. It may be advantageous, for example, to increase the spacing of the optical elements of the transmitting device 12 by means of longer beam paths. Such a length of the second optical path may be achieved by the deflection unit ABL, while at the same time the necessary space for the device may be kept small. Optionally, the deflection unit ABL, for example its orientation in space, may be controlled by the object simulator 14. However, it is possible for the deflection unit ABL to be static and always positioned the same, so that the light L2 is a function only of how it is emitted by the transmitting device 12 and how it thus strikes the deflection unit ABL. In addition to the illustrated components, it is also possible for further optical elements such as lenses, other mirrors, and optical diodes to be situated in the optical paths. The deflection unit ABL thus allows an even more compact arrangement.

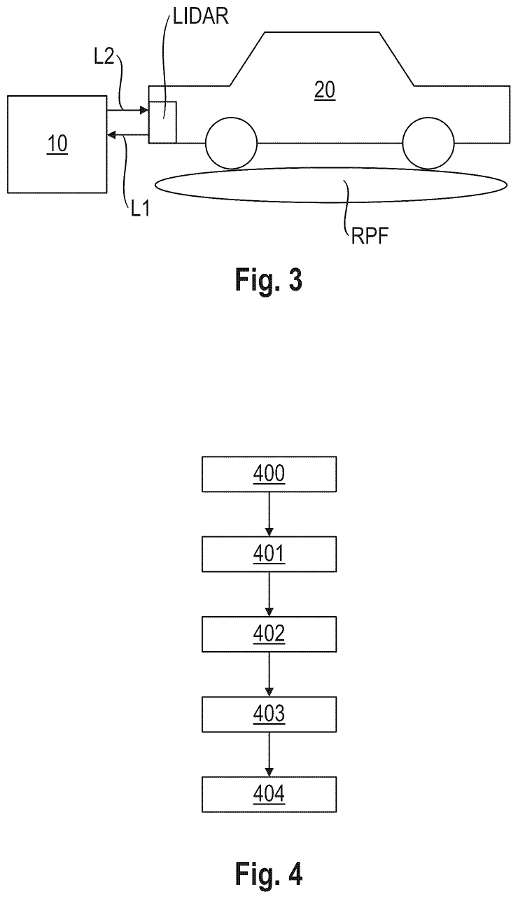

FIG. 3 shows a test stand together with the device 10. A vehicle 20 includes the lidar sensor LIDAR, which emits the first light L1 into the device 10. The lidar sensor LIDAR receives the second light L2 from the device 10. The vehicle 20 rests on a roller test stand RPF, via which the vehicle 20 may be moved at a certain speed and acceleration. In this way scenarios, for example for autonomous driving, may be tested which can verify the functional capability of the lidar sensor LIDAR. In the present case, the lidar sensor LIDAR is in its actual installed position in the vehicle 20, for example in or at the headlights, in or at the bumper or other elements at the front end of the vehicle. Some other arrangement, for example at the upper edge of the windshield, is also possible. The lidar sensor LIDAR and/or further lidar sensors may be situated in other areas of the vehicle 20. The device 10 may then be situated appropriately in the visual field of the lidar sensor for testing.

FIG. 4 shows a flow chart of an example of the method for testing the lidar sensor LIDAR.

The lidar sensor LIDAR outputs the first light L1 on the first optical path in method step 400.

The trigger detector TD receives the first light L1 on the first optical path in method step 401. After step 400 and before step 401, the first light L1 received by the trigger detector TD has optionally passed through the optical element DS.

The trigger detector TD generates the trigger signal TS in method step 402 as a function of the received first light L1.

In method step 403 the object simulator 14 generates the control signal SE as a function of the trigger signal TS, and transfers the control signal SE to the transmitting device 12, 12.1, 12.2 and/or the movement device BE. The generation of the control signal SE as a function of the trigger signal TS is carried out by the object simulator 14, as described with reference to FIGS. 1 or 2, for example.

The transmitting device 12, 12.1, 12.2 generates the second light L2 as a function of the control signal SE and emits it on the second optical path. Based on the control signal SE, the movement device BE derives a movement of the at least one transmitting device 12, 12.1, 12.2 and correspondingly moves the transmitting device 12, 12.1, 12.2. The movement device BE changes the location and/or the direction of the emission of the second light L2. For example, the course of a particular second optical path may be altered by changing the inclination, i.e., the tilt angle, of the transmitting device 12, 12.1, 12.2.

The second light L2 is received on the second optical path by the lidar sensor LIDAR in method step 404. After step 403 and before step 404, the second light L2 received on the second optical path by the lidar sensor LIDAR has optionally passed through the optical element DS.

The lidar sensor LIDAR can then generate a reception signal. As a function of this reception signal, the lidar sensor LIDAR can generate a test signal or some other output signal, for example, on the basis of which the success of the testing of the lidar sensor LIDAR may be assessed.

The optical element DS may be situated in the first optical path and the second optical path. The optical element DS then separates the first optical path and the second optical path in such a way that the first optical path and the second optical path run crosswise relative to one another after the separation. This separation takes place using the particular wavelengths of the first light and the second light, for example using a dichroic mirror or some other optical element that operates based on wavelengths.

The first optical path of step 400 and the second optical path of step 404 may thus extend in parallel or essentially in parallel to one another, so that a realistic reception situation may be simulated for the lidar sensor LIDAR. The first optical path of step 401 and the second optical path of step 403 thus can run crosswise relative to one another, so that the trigger detector TD and the transmitting device 12 can be situated apart from one another.

Thus, it is possible to position the transmitting device 12 in such a way that the transmitting device itself is not perceived by the lidar sensor LIDAR as an object in the surroundings. The transmitting device may be positioned outside the visual field of the lidar sensor LIDAR and still emit the second light L2 for the reception by the lidar sensor LIDAR.

The second light L2 may alternatively or additionally be guided onto the optical element DS via the deflection unit ABL, and subsequently received by the lidar sensor LIDAR.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for testing a lidar sensor, the lidar sensor being configured to emit a first light, the device comprising:
a trigger detector that is configured to receive the first light on a first optical path, the trigger detector being configured to generate a trigger signal as a function of the received first light;
at least one transmitting device that is configured to emit a second light as a function of the trigger signal, the second light being receivable on a second optical path by the lidar sensor; and
a movement device that is configured to move the at least one transmitting device as a function of a control signal.

2. The device according to claim 1, wherein the movement device is configured to change the location and/or the direction of the emission of the second light as a function of the control signal.

3. The device according to claim 1, wherein the at least one transmitting device comprises a field of light sources, the light sources being activatable independently of one another.

4. The device according to claim 1, wherein multiple transmitting devices are provided which are movable independently of one another by the movement device.

5. The device according to claim 1, wherein an object simulator is provided to generate the control signal as a function of the trigger signal, wherein the emission of the second light is a function of the control signal, and wherein an object is simulatable by the second light for the lidar sensor.

6. The device according to claim 5, wherein one or more transmitting devices simulate the object.

7. The device according to claim 1, further comprising an optical element that is configured to separate the first optical path from the second optical path on a side facing away from the lidar sensor.

8. The device according to claim 1, wherein the first light is emitted at a first wavelength and the second light is emitted at a second wavelength, wherein the first wavelength is not equal to the second wavelength, and wherein a separation of the first optical path and of the second optical path is a function of the wavelength.

9. The device according to claim 8, wherein the optical element is a dichroic mirror.

10. The device according to claim 1, wherein the at least one transmitting device and the trigger detector are arranged spatially separate from one another.

11. The device according to claim 10, wherein the trigger detector is movable as a function of the location and/or the direction of the emission of the second light.

12. The device according to claim 1, wherein at least one optical deflection unit is provided in the second optical path, via which the second light emitted by the at least one transmitting device is deflectable to the optical element.

13. The device according to claim 12, wherein the optical deflection unit includes at least one mirror.

14. A test stand, in particular a roller test stand, for a vehicle, the test stand comprising:
a lidar sensor; and
the device according to claim 1.

15. A method for testing a lidar sensor, the method comprising:
emitting a first light by the lidar sensor;
receiving the first light on a first optical path by a trigger detector;
generating a trigger signal by the trigger detector as a function of the received first light;
emitting a second light by at least one transmitting device as a function of the trigger signal;
receiving the second light on a second optical path by the lidar sensor;
moving, via a movement device, the at least one transmitting device as a function of a control signal.

16. The method according to claim 15, wherein the movement device changes the location and/or the direction of the emission of the second light as a function of the control signal.
